(19) United States
(12) Patent Application Publication
(10) Pub. No.: US 2005/0201895 A1
(43) Pub. Date: Sep. 15, 2005

(54) Systems and methods for delivering a sample fluid to a receiving substrate

(76) Inventor: Eric Donsky, Los Angeles, CA (US)

Correspondence Address: BAKER & MCKENZIE;PATENT DEPARTMENT, 2001 ROSS AVENUE, SUITE 2300, DALLAS, TX, 75201, US

(21) Appl. No.: 10/800,398

(22) Filed: Mar. 12, 2004

(51) Int. Cl. G01N 13/04

(52) U.S. Cl. 422/63; 73/64.56; 73/64.47

(57) ABSTRACT

A sample delivery system provides systems and methods for capturing, lowering, and then dispensing a collected sample fluid to a receiving substrate. Specifically, an aliquot of sample fluid, such as a human tear film, is collected with a collection device such as a capillary tube. A receiving device is used to capture the capillary tube, and the receiving device is coupled to a mechanical translation system. The translation system provides for both coarse and fine adjustment to position the capillary tube in proximity with the receiving substrate.

### RELATED APPLICATIONS INFORMATION

This application is related to U.S. patent application Ser. No. 10/718,498, entitled, “Systems and Methods for Measuring Tear Film Osmolarity”, filed on Nov. 19, 2003, U.S. patent application Ser. No. 10/772,084, entitled, “Systems and Methods for Calibrating Osmolarity Measuring Devices”, filed on Feb. 4, 2004, and U.S. patent application Ser. No. TBD, entitled, “Tear Film Osmometry”, filed on Mar. 25, 2002, each of which is incorporated herein by reference in its entirety as if set forth in full.

### BACKGROUND

1. Field of the Inventions

The field of the invention relates generally to osmolarity measurements and more particularly to systems and methods for delivering an aliquot of sample fluid to a receiving substrate.

2. Background Information

Tears fulfill an essential role in maintaining ocular surface integrity, protecting against microbial challenge, and preserving visual acuity. These functions in turn, are critically dependent upon the composition and stability of the tear film structure, which includes an underlying mucin foundation, a middle aqueous component, and an overlying lipid layer. Disruption, deficiency, or absence of the tear film can severely impact the eye.

An increased salt concentration (osmolarity) of the human tear film has been identified as the underlying causative mechanism for all types of dry eye. Chronically heightened osmolarity is tied to post-LASIK complications, keratoconjunctivitis sicca, and contact-lens induced dry eye. While its usefulness as a marker of tear film health is evident, the ability to rapidly measure tear osmolarity has eluded science for decades.

Currently, the only known clinical device for measuring tear osmolarity makes use of bare metal electrodes printed on a microchip. While collecting human tears via glass capillary is a very noninvasive, standard ophthalmic practice, patients suffering from dry eye syndrome (DES) carry very little tear volume, often in the tens of nanoliters. As a consequence of the nanoscale volume, delivery of a clinical sample of tears or other fluids to a receiving substrate for analysis is of premium importance and must be performed correctly on the first attempt as repeated collections of human tears may stimulate reflex tearing, which will artificially lower the collected tear osmolarity and compromise the clinical efficacy of the analyte.

The dominant microfluidic technologies for deposition of sub-nanoliter volumes are ink jet devices and spotting techniques. These mechanisms have found widespread use in high-throughput chemistry and first generation DNA microarrays. Current inkjets are able to repeatedly deposit picoliter sized droplets of fluid. The jet is comprised of a microfluidic tube leading from the ink supply at one end to the nozzle opening at the other end. Through actuation of piezoelectric micro-electro-mechanical systems (MEMS), an applied acoustic wave will travel through the column of ink and rebound at the outlet of the jet, pinching off the desired amount of fluid as the wave propagates back through the column.

While this ability to repeatedly deliver sub-nanoliter volumes of fluid has become commonplace, the ink-jet effect works only under tightly controlled conditions. First, in order to achieve the required volumetric precision, the inks have been so well tuned that their surface tension is perfectly balanced against the force of the incident wave. Second, ink jet technology requires a large reservoir of fluid at the far end of the jet column to ensure adequate pressure and a continuous supply of ink. That is, the microscale effects of the ink jets are one sided. Due to these issues, ink jet technology is not suitable for general delivery of varying fluid types (because their surface tension will change), initially small fluidic volumes (because the reservoir does not exist), protein based fluids which might stick to the walls of a delivery column (because of nonlinear adhesion during expulsion) or one-time use disposable elements that would become prohibitively expensive with embedded MEMS. Thus, current ink jet technology is not suitable for one-time delivery of sample fluid from dry eye patients.

Traditional spotting technology, which is essentially a microfluidic version of the ball point pen, uses a very sharp needle to place a small droplet of fluid onto a region of interest. Generally, the needle is dipped into a reservoir, often in 96- or 384-well format. Upon extraction, the adhesive forces at the tip of the needle draw a well defined amount of fluid onto the spotter. The needle is then translated to the region of interest and touched down, whereupon the fluid is pulled off the tip by surface interactions. While this procedure can deliver miniscule amounts of sample, the needle exposes the sample to air while translating. Spotting is therefore incompatible with aqueous solutions of tears because the evaporation during transport will change the final concentration at the receiving substrate. Furthermore, physical contact with the receiving substrate during spotting precludes its use with bare microelectrode arrays, which have sensitive metal layers coating the outside of the electrode. Finally, spotting technologies rely upon fixed distances from the translation arm when controlling vertical placement. Therefore, spotting is not currently amenable to multiple human interactions where the initial height of the capillary varies.

Accordingly, the osmolarity measurements on the nanoscale level requires the ability to deliver nanoliters of fluid (for example, human tears), from a collection device to a receiving substrate in a spatially precise manner. More particularly, a user should be able to collect and deliver nanoliters of biological fluid with the same capillary tube. Upon delivery, the capillary tube should not spray the sample into multiple pools, the tip of the capillary should not make physical contact with the receiving substrate, and the final area over which the fluid is spread should not exceed a predefined area. Because the physical properties of a sample fluid will vary between patients, and the initial volume may be on the order of tens of nanoliters, both ink jet and traditional spotting technologies are unsuitable for this application.

### SUMMARY OF THE INVENTION

A sample delivery system provides systems and methods for capturing, lowering, and then dispensing a collected sample fluid to a receiving substrate. In one aspect, an aliquot of sample fluid, such as human tear film, is collected with a collection device such as a capillary tube. A receiving device is used to capture the capillary tube, and the receiving device is coupled to a mechanical translation system. The translation system provides for both coarse and fine adjustment to position the capillary tube in proximity with the receiving substrate. In another aspect, the receiving substrate includes a microelectrode array for measuring electrical properties of the sample fluid. The translation system uses an electrical field mediated control system or an optical control system to detect to presence of the capillary tube and stop the lowering of the capillary tube. Once the capillary tube is in position, the sample fluid is either expelled through a actuated pressure signal and/or wicked out of the capillary by hydrophilic moietes at an inlet of a microfluidic channel in series with the receiving substrate. After the fluid has been delivered to the receiving substrate, measurement of the sample fluid is initiated.

In another aspect, the sample delivery systems and methods include an angled block with a triangular or circular groove on one face of the block. The groove is configured to capture a collection device, such as a capillary tube, while allowing the collection device to slide down the groove toward the receiving substrate. Accordingly, the collection device can be manually positioned through the trained hand of a clinician. Once the collection device is positioned in proximity with the receiving substrate, the sample is expelled and measurements of the sample fluid can be initiated. These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 is a diagram illustrating a sample delivery system with an example embodiment of the invention;

FIG. 2 is a diagram illustrating a sample delivery system with another example embodiment of the invention;

FIG. 3 is a diagram illustrating a sample delivery system with another example embodiment of the invention;

FIG. 4 is a flow chart illustrating a method for delivering a sample fluid to a receiving substrate in accordance with an example embodiment of the invention.

### DETAILED DESCRIPTION OF THE PREFERRED EMBODIMENTS

The systems and methods described herein provide a method to capture, lower and then deliver a collected sample fluid to a receiving substrate. Generally, a receiving device is used to secure a collection device, such as a capillary tube. The collection device is mechanically translated until it is in such close proximity to the receiving substrate that upon expulsion, the sample fluid will not fragment, nor exceed a critical volume which may cross pre-defined physical barriers, such as the extent of an microelectrode array on the receiving substrate. The sample delivery system avoids injuring the metallization of the substrate while maximizing the delivered sample volume within a defined area.

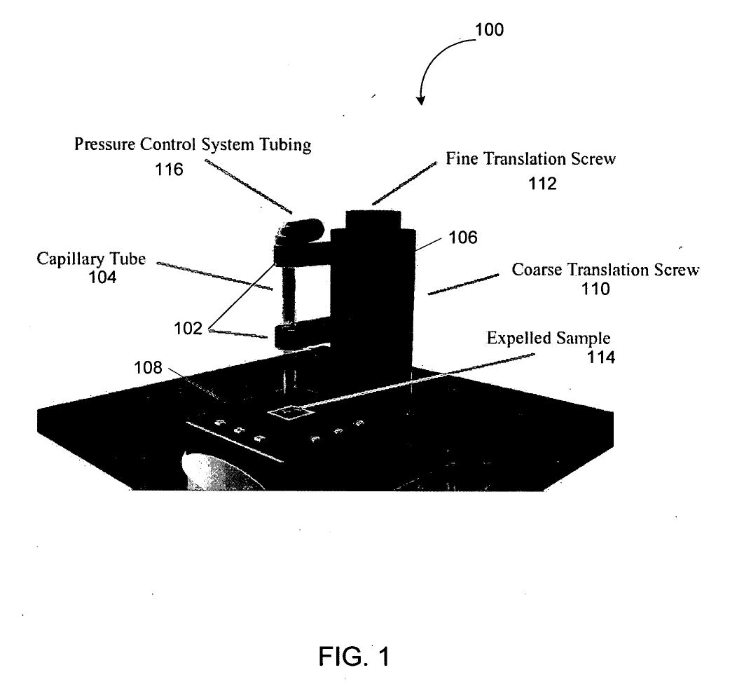

FIG. 1 illustrates an exemplary embodiment of a sample delivery system 100. In the FIG. 1 embodiment, the sample delivery system 100 includes a receiving device 102 for capturing a collection device such as capillary tube 104. In this sense, capture refers to the ability of the sample delivery system 100 to hold onto the collection device. In one embodiment, capillary tube 104 is placed into a standard rubber plug with a capillary sized hole bored through the middle, or tightly-fit rubber tubing to provide the receiving device 102. In another embodiment, the receiving device 102 comprises an additional standard rubber plug to provide additional support for securing the capillary tube 104.

In yet another embodiment, the shaft of the capillary tube is grasped or constrained such that its degrees of freedom are reduced by the receiving device. In one form, the receiving device includes a mechanical forceps with pliable, but firm rubber tips to prevent damage to the capillary tube. The forceps can be manually controlled via a thumb screw or computer controlled via force transduction at the tips. A second form of grasping device includes a metal arm with a hole bored through the center and a screw positioned perpendicular to the shaft of the capillary; upon insertion of the capillary and tightening of the screw, the capillary is forced along a vertical path. Another embodiment of the receiving device comprises a vertically or acutely oriented block with a circular or triangular groove down the middle. Attached to the block is a hinged door with a flat rubber face. When closed, the door applies enough pressure to the capillary to secure the tube in place but not damage the capillary.

Once capillary tube 104 is captured by receiving device 102, a translation system 106 is used to adjust the vertical position of receiving device 102, and therefore, capillary tube 104. In one embodiment, a vertical translation system is coupled to a non-tapered cylindrical screw. The rotation of the screw is converted into a linear translation and provides a vertical adjustment for the receiving device 102 that secures the capillary tube 104. In one embodiment, a control system sends commands to a motorized screw rotor such that the vertical precision of the translation system 106 can go from coarse to fine simply by modulating the speed at which the screw turns. By optimizing the thread density and angle of the screw, micrometer precision is possible with inexpensive motor components.

In another embodiment, the translation system 106 includes two concentric screws that are used for vertical positioning. The screws are concentrically fastened, such that the outer coarse translation screw 110 has a steep thread angle and low thread density, while the inner fine translation screw 112 (positioned in the outer screw's center) has a shallow thread angle and high thread density.

In one embodiment, the fine translation screw 112 may have ten times the thread density of the coarse translation screw 110. The screws are turned in concert to bridge the initial coarse distance away from the receiving substrate via the outer thread pattern. Once the capillary tube 104 approaches the receiving substrate 108, the fine translation screw 112 is turned alone. Accordingly, with the same rate of rotation, the vertical precision of the translation system 106 is ten times greater than the initial movement with the coarse translation screw 110. In comparison to a single screw system, a double screw system reduces the time it takes to lower the capillary tube 104 to the receiving substrate 108, protecting against evaporation of the sample fluid. Furthermore, because lower rotation rates can be used with a double screw system, the gain of the control system can be reduced to increase dynamic stability. The increase in dynamic stability helps ensure that the translation system has sufficient time to stop the motion of the receiving device 102 to prevent contact between the capillary tube 104 and the receiving substrate 108.

In one embodiment, the mechanical translation platform uses an electrical field mediated control system to determine when to stop lowering the collection device, such as capillary tube 104, towards the receiving substrate. For example, as shown in FIG. 1, the presence of capillary tube 104 disturbs the electrical fields of the electrode pairs located on receiving substrate 108. Because the vertical extent of the electric field between the electrode pairs is very shallow, the detectable presence of capillary tube 104, or the sample fluid edge within the electrical field indicates a very specific distance away from the surface of the receiving substrate 108. Upon recognition of this distance, the vertical translation of capillary tube 104 is halted. If capillary tube 104 is being lowered manually, visual or auditory feedback can be sent to the user in the form of a light or LED that illuminates when the capillary enters the field. The electrical feedback method is useful because no extra hardware beyond the microchip is necessary to implement a control loop.

In another embodiment, an optical control system is used to determine the vertical position of the lower edge of a collection device, such as capillary tube 104. In one embodiment of the optical control system, two juxtaposed fiber optic lines are placed at the base of the receiving substrate 108. When capillary tube 104 breaks contact between the lines, a feedback signal is sent to the translation controller to halt the vertical translation of capillary tube 104. The feedback can also be visual, where someone manually lowering a sample would see a light triggered by the breaking of the receiving substrate plane. This feedback would indicate to the user to halt the vertical translation of capillary tube 104 and deposit the sample.

Multiple technical variations of the optical control system are possible. For example, a laser, LED or other optical source can be used to replace one of the juxtaposed fiber optic lines. Alternatively, the source could be raised off the surface of receiving substrate 108 and angled at receiving substrate 108. A sensor then measures the reflected or transmitted change in light intensity upon capillary intrusion into the area of interest. The optical method is useful by itself, but also useful because it allows a two stage control system to be implemented. The optical sensor tracks the coarse position of capillary tube 104 and relies upon the electrical control system to guide the fine grained movement. These subsystems are optimal when used in conjunction with the aforementioned double screw assembly because the coarse movement ensures usability and the fine adjustment gives the necessary precision.

Once the capillary tube 104 has been positioned in close proximity to the receiving substrate 108, the sample fluid is deposited on or into the receiving substrate 108 through an expulsion action. When a sample includes only a small volume of fluid, such as a human tear film, the use of inefficient fluidic coupling stages, such as macroscale valving or standard macro to microfluidic input stages, is precluded. Instead, all fluid handling must be done completely on the microscale. Therefore, the single expulsion of the sample must be efficient and controlled such that there is no spatter or imprecision in the placement.

After capillary tube 104 is lowered into place using the methods described above, the fluid can be expelled in a variety of ways. In one embodiment, simple pressure driven expulsion is achieved where capillary tube 104 includes a rubber bulb sealed on the top of capillary tube 104. The rubber bulb is gently squeezed until the fluid has been completely evacuated from capillary tube 104 to produce an expelled sample 114 on receiving substrate 108.

In another embodiment, pressure control system tubing 116 is attached to the top of capillary tube 104 and expulsion of the sample fluid is computer actuated. The pressure control system slowly builds up the pressure inside the capillary until the sample emerges from the tip of the capillary tube 104. At the point when the surface tension of the sample fluid equals the gauge pressure of the capillary tube 104, the droplet of suspended fluid is lowered onto the receiving substrate by the translation system 106 to disrupt the balance of the droplet. Upon contact, the fluid wets the surface of the receiving substrate 108 and measurements of the sample fluid can be initiated. Simultaneously, the translation system 106 will begin to raise the capillary tube 104 as the pressure control system expels the remaining sample fluid. This is performed without the capillary ever touching the receiving substrate, and optimally performed at a height equivalent to that of the droplet height of expelled fluid volume. It is important to raise the capillary while keeping a continuous pressure on the fluid to counteract any capillary action that may result in reuptake of the delivered sample.

In another embodiment, the expulsion action relies upon the electrical interaction of the receiving substrate 108 and capillary tube 104 to initiate an electroosmotic flow through the column of fluid to extract the sample. When capillary tube 104 is close enough to an array of electrodes to disrupt the steady electric field, the outside ring of electrodes establishes a pulsed field across the lumen of capillary tube 104, thereby inducing enough electroosmotic flow to pull an aliquot of fluid off the capillary tip. Upon fluid contact, the electric field is turned off to avoid electrolysis.

Another embodiment uses a stronger capillary action from a delivery stage coupled directly to receiving substrate in order to pull out the sample fluid from the capillary. This can be accomplished by coupling a microchannel to the receiving substrate that has strongly hydrophilic properties. These properties may achieved through use of different substrate materials, geometries, or other coatings such as PEG (polyethylene glycol) around the entrance to the delivery stage. This serial delivery stage may be used alone or in conjunction with the aforementioned pressure mediated delivery systems.

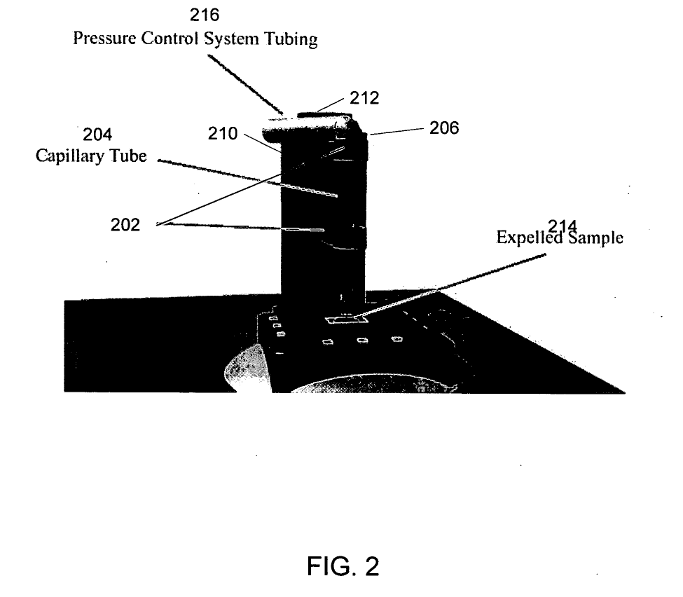

FIG. 2 illustrates a front view of another exemplary embodiment of a sample delivery system 200. In the FIG. 2 embodiment, the sample delivery system 200 includes a receiving device 202 for capturing a collection device such as capillary tube 204. The receiving device 202 includes a standard rubber plug with a capillary sized hole bored through the middle and configured to secure capillary tube 204. In another embodiment, the receiving device 202 comprises an additional standard rubber plug. The receiving device 202, and therefore, capillary tube 204, are coupled to translation system 206, which is configured to position capillary tube 204 in close proximity with receiving substrate 208. In one embodiment, receiving substrate 208 includes at least one pair of measuring electrodes for measuring electrical properties of the sample fluid. Translation system 206 provides vertical positioning of the receiving device 202 and capillary tube 204 through the use of coarse translation screw 210 and fine translation screw 212. Once capillary tube 204 has been positioned in close proximity to receiving substrate 204, the sample fluid is deposited on the receiving substrate 208 through an expulsion action to produce expelled sample 214. In one embodiment, the sample delivery system 200 is equipped with pressure control system tubing 216 to facilitate a computer actuated expulsion action.

As discussed above, one embodiment of sample delivery system 200 uses an electrical field mediated control system to determine when to stop lowering capillary tube 204 towards receiving substrate 208. The presence of capillary tube 204 disturbs the electric fields of the electrodes included on receiving substrate 208. Because the vertical extent of the electric field between the electrodes is very shallow as shown in FIG. 2, the detectable presence of capillary tube 204 within the field indicates a very specific distance away from the surface of receiving substrate 208. As discussed above, the vertical translation of capillary tube 204 should be halted upon recognition of this distance.

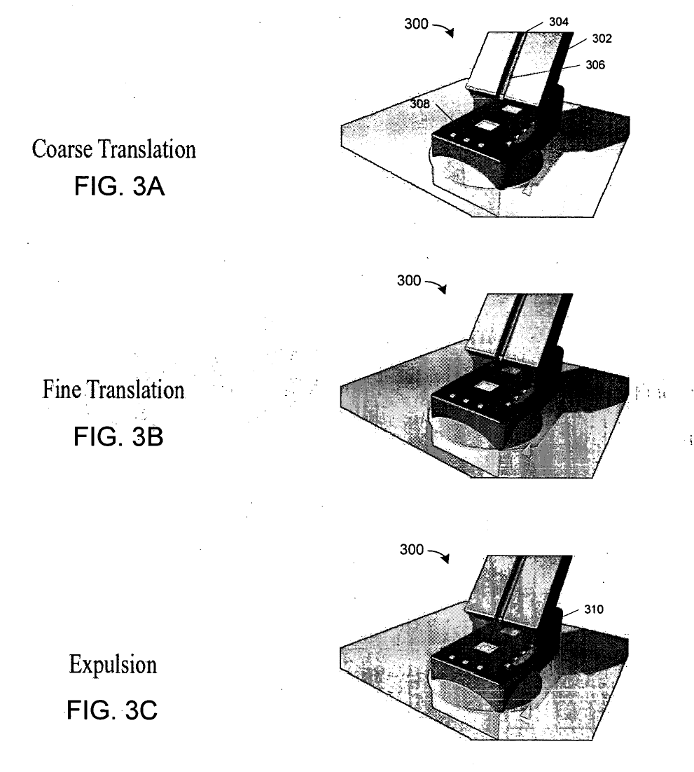

FIG. 3 illustrates another embodiment of a sample delivery system 300, and includes FIG. 3a demonstrating coarse translation, FIG. 3b demonstrating fine translation, and FIG. 3c demonstrating sample expulsion. The FIG. 3 embodiment includes a receiving device 302. In one embodiment, receiving device 302 comprises an angled block with a circular or triangular groove 304 down the middle. The groove is configured to receive a collection device such as capillary tube 306. The groove is further configured to secure capillary tube 306 in place while allowing capillary tube 306 to slide down groove 304 upon the application of force to capillary tube 306. Accordingly, receiving device 302 is configured to support capillary tube 306 as it is manually lowered towards the receiving substrate 308 as shown in FIG. 3a through coarse translation. This sample delivery system is inexpensive and is generally amenable to the trained hand of a clinician. Once capillary tube 306 approaches receiving substrate 308, the clinician manually positions capillary tube 306 in close proximity with receiving substrate 308 through fine translation as shown in FIG. 3b. Translation of capillary tube 306 is stopped when the control system emits either auditory or visual feedback to the user as discussed above. Once capillary tube 306 is in close proximity with receiving substrate, an expulsion action is applied to capillary tube 306 and expelled sample 310 is introduced to receiving substrate 308.

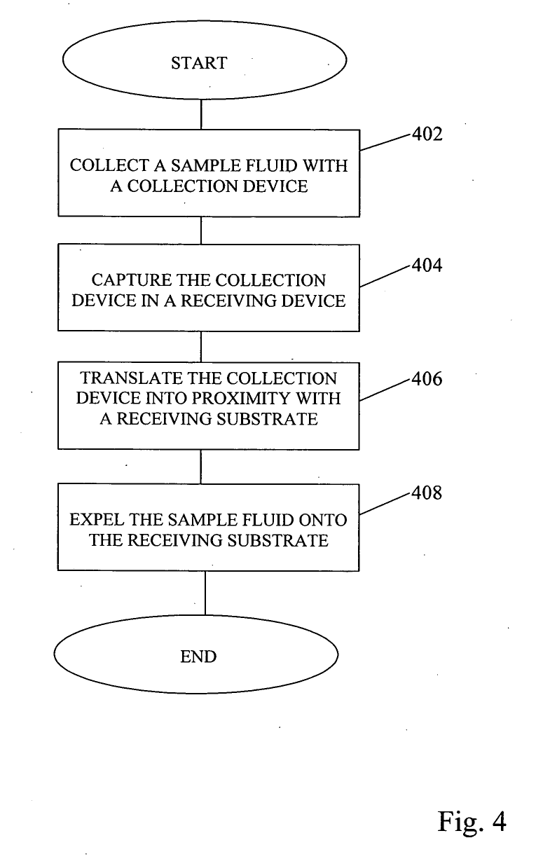

FIG. 4 is a flow chart illustrating an example embodiment of a method for delivering a sample fluid to a receiving substrate in accordance with one embodiment of the systems and methods described herein. At box 402, a sample fluid is collected in a collection device. Exemplary embodiments are described for delivering an aliquot volume of a sample fluid such as tear film, sweat, blood, or other fluids. In one embodiment, a trained clinician collects an aliquot of human tear film in a capillary tube by manually contacting the capillary tube to the ocular surface of an individual.

Once the sample fluid has been collected at box 402, the collection device is captured in a receiving device at box 404. In this sense, capture refers to the ability of the sample delivery system to hold onto the collection device. The systems and methods for capturing the collection device include the exemplary embodiments discussed above such as the use of a standard rubber plug with a capillary sized hole bored through the middle; tightly-fit rubber tubing for pressure control; the use of multiple standard rubber plugs; mechanical forceps; a vertically oriented block with a groove down the middle for capturing the capillary tube; a metal arm with a bore and perpendicular screw; and a block with a hinged door with a flat rubber face configured to apply pressure to the external walls of the capillary tube. In these embodiments, the receiving device, and therefore the collection device, are coupled to a mechanical translation system for translating the capillary tube into proximity with the receiving substrate at box 406. The mechanical translation system that is used to translate the collection device at box 406 includes the systems and methods described above such as the use of a non-tapered cylindrical screw coupled to the receiving device and the use of two concentric screws including a coarse translation screw and a fine translation screw.

In another embodiment, the collection device is captured in a receiving device at box 404, and the receiving device includes an angled block with a groove down the middle. In one embodiment, the capillary tube is secured in the groove but also allowed to slide down the grove through the application of force to the capillary tube. Accordingly, in one embodiment, translating the capillary tube into proximity with the receiving substrate at box 406 is generally amenable to the trained hand of a clinician.

Once the collection device is in proximity with the receiving substrate, the sample fluid is expelled onto the receiving substrate at box 408 in accordance with the exemplary embodiments described above, including the application of air pressure from a squeezable rubber bulb; wicking via a delivery stage placed in series with the receiving substrate; and/or a control system coupled to the capillary tube through pressure system tubing. Once the sample has been expelled onto the receiving substrate, measurements of the sample fluid can be initiated.

While certain embodiments of the inventions have been described above, it will be understood that the embodimrents described are by way of example only. Accordingly, the inventions should not be limited based on the described embodiments. Rather, the scope of the inventions described herein should only be limited in light of the claims that follow when taken in conjunction with the above description and accompanying drawings.

1. An osmolarity measuring system, comprising:
a fluid sample receiving chip comprising a fluid receiving substrate; and
sample delivery system configured to deliver a sample of fluid to the sample receiving substrate, the sample delivery system comprising:
a receiving device configured to capture a collection device used to collect the sample fluid,
a translation system configured to position the collection device in proximity with the fluid receiving substrate, and
an expulsion device configured to deliver the sample of fluid to the fluid receiving substrate.

2. The osmolarity measuring system of claim 1, wherein the receiving substrate comprises a microelectrode array.

3. The osmolarity measuring system of claim 1, wherein the collection device is a capillary tube.

4. The osmolarity measuring system of claim 1, wherein the sample fluid comprises an aliquot of tear film.

5. The osmolarity measuring system of claim 1, wherein the receiving device comprises a first rubber plug configured to capture the collection device.

6. The osmolarity measuring system of claim 5, wherein the receiving device comprises a second rubber plug configured to capture the collection device.

7. The osmolarity measuring system of claim 1, wherein the receiving device comprises forceps configured to capture the collection device.

8. The osmolarity measuring system of claim 7, further comprising a thumb screw coupled to the forceps, the thumb screw configured to control the forceps.

9. The osmolarity measuring system of claim 7, further comprising a computer coupled to a pressure sensor on the forceps, the computer configured to control the forceps.

10. The osmolarity measuring system of claim 1, wherein the receiving device comprising a block, wherein the block includes a groove, the groove configured to receive the collection device.

11. The osmolarity measuring system of claim 10, wherein the block is an angled block.

12. The osmolarity measuring system of claim 10, further comprising a hinged door configured to apply pressure to the collection device.

13. The osmolarity measuring system of claim 1, wherein the translation system is configured to adjust the vertical position of the collection device.

14. The osmolarity measuring system of claim 13, wherein the translation system comprises a non-tapered cylindrical screw.

15. The osmolarity measuring system of claim 14, wherein the translation system further comprises a control system and a motorized screw rotor coupled to the non-tapered cylindrical screw.

16. The osmolarity measuring system of claim 13, wherein the translation system comprises a coarse translation screw and a fine translation screw.

17. The osmolarity measuring system of claim 13, further comprising a control system configured to communicate with the translation system and position the collection device in proximity with the receiving substrate.

18. The osmolarity measuring system of claim 17, wherein the control system comprises an optical control system configured to identify when the capillary tube interrupts a light source near the receiving substrate.

19. The osmolarity system of claim 13, wherein the receiving substrate comprises a microelectrode array, with an associated electric field that extends a certain vertical distance form the surface of the receiving substrate, and wherein the translation system uses the electric field to position the collection device in relation to the surface of the receiving substrate.

20. The osmolarity measuring system of claim 19, wherein the translation system is configured to stop lowering the collection device when the collection device is close enough to the receiving substrate to interrupt the electric field.

21. The osmolarity measuring system of claim 20, further comprising a control system coupled with the microelectrode array and the translation system, the control system configured to detect when the collection device interrupts the electric field and signal the translation system to stop lowering the collection device.

22. The osmolarity measuring system of claim 19, further comprising an indicator and a control system coupled with the microelectrode array and the indicator, the control system configured to detect when the collection device interrupts the electric field and to activate the indicator so that lowering of the collection device can be stopped.

23. The osmolarity measuring system of claim 1, wherein the expulsion device comprises a rubber bulb coupled to the capillary tube, the rubber bulb configured to be squeezed and apply pressure to the sample fluid.

24. The osmolarity measuring system of claim 1, wherein the expulsion device comprises a control system coupled to the capillary tube, the control system configured to apply pressure to the sample fluid.

25. The osmolarity measuring system of claim 1, wherein the receiving substrate comprises a microelectrode array, with an associated electric field that extends a certain vertical distance form the surface of the receiving substrate, and wherein the electric field generates an electroosmotic flow through the collection device causing the sample of fluid to be expelled.

26. The osmolarity measuring system of claim 1, wherein the receiving device comprises a metal arm configured to capture the collection device.

27. The osmolarity measuring system of claim 26, Wherein the metal arm comprises a hole bored through the center of the metal arm through which the collection device is inserted.

28. The osmolarity measuring system of claim 27, wherein the receiving device further comprises a screw fashioned perpendicular to the bore configured to align the collection device down the center of the bore when tightened.

29. The osmolarity measuring system of claim 1, wherein the expulsion device comprises a wicking mechanism placed in series with the receiving substrate.

30. The osmolarity measuring system of claim 29, wherein the wicking mechanism is a microchannel.

31. The osmolarity measuring system of claim 30, wherein the microchannel comprises enhanced hydrophilic properties.

32. The osmolarity measuring system of claim 31, wherein the enhanced hydrophilic properties are achieved via at least one of a certain geometry, a substrate material and an applied coating.

33. An osmolarity measuring system, comprising:
a fluid sample receiving chip comprising a fluid receiving substrate, the fluid receiving substrate comprising a microelectrode array with an associated electric field extending a certain vertical distance from the surface of the receiving substrate; and
sample delivery system configured to deliver a sample of fluid to the sample receiving substrate, the sample delivery system comprising:
a receiving device configured to capture a collection device used to collect the sample fluid, and
a translation system configured to position the collection device in proximity with the fluid receiving substrate.

34. The osmolarity measuring system of claim 33, wherein the collection device is a capillary tube.

35. The osmolarity measuring system of claim 33, wherein the sample fluid comprises an aliquot of tear film.

36. The osmolarity measuring system of claim 33, wherein the receiving device comprises a first rubber plug configured to capture the collection device.

37. The osmolarity measuring system of claim 36, wherein the receiving device comprises a second rubber plug configured to capture the collection device.

38. The osmolarity measuring system of claim 33, wherein the receiving device comprises forceps configured to capture the collection device.

39. The osmolarity measuring system of claim 38, further comprising a thumb screw coupled to the forceps, the thumb screw configured to control the forceps.

40. The osmolarity measuring system of claim 38, further comprising a computer coupled to a pressure sensor on the forceps, the computer configured to control the forceps.

41. The osmolarity measuring system of claim 33, wherein the receiving device comprising a block, wherein the block includes a groove, the groove configured to receive the collection device.

42. The osmolarity measuring system of claim 41, wherein the block is an angled block.

43. The osmolarity measuring system of claim 41, further comprising a hinged door configured to apply pressure to the collection device.

44. The osmolarity measuring system of claim 33, wherein the translation system is configured to adjust the vertical position of the collection device.

45. The osmolarity measuring system of claim 44, wherein the translation system comprises a non-tapered cylindrical screw.

46. The osmolarity measuring system of claim 45, wherein the translation system further comprises a control system and a motorized screw rotor coupled to the non-tapered cylindrical screw.

47. The osmolarity measuring system of claim 44, wherein the translation system comprises a coarse translation screw and a fine translation screw.

48. The osmolarity measuring system of claim 44, further comprising a control system configured to communicate with the translation system and position the collection device in proximity with the receiving substrate.

49. The osmolarity measuring system of claim 44, wherein the control system comprises an optical control system configured to identify when the capillary tube interrupts a light source near the receiving substrate.

50. The osmolarity system of claim 44, wherein the translation system uses the electric field to position the collection device in relation to the surface of the receiving substrate.

51. The osmolarity measuring system of claim 50, wherein the translation system is configured to stop lowering the collection device when the collection device is close enough to the receiving substrate to interrupt the electric field.

52. The osmolarity measuring system of claim 51, further comprising a control system coupled with the microelectrode array and the translation system, the control system configured to detect when the collection device interrupts the electric field and signal the translation system to stop lowering the collection device.

53. The osmolarity measuring system of claim 50, further comprising an indicator and a control system coupled with the microelectrode array and the indicator, the control system configured to detect when the collection device interrupts the electric field and to activate the indicator so that lowering of the collection device can be stopped.

54. The osmolarity measuring system of claim 33, wherein the electric field generates an electroosmotic flow through the collection device causing the sample of fluid to be expelled.

55. The osmolarity measuring system of claim 33, wherein the receiving device comprises a metal arm configured to capture the collection device.

56. The osmolarity measuring system of claim 55, Wherein the metal arm comprises a hole bored through the center of the metal arm through which the collection device is inserted.

57. The osmolarity measuring system of claim 54, wherein the receiving device further comprises a screw fashioned perpendicular to the bore configured to align the collection device down the center of the bore when tightened.

58. The osmolarity measuring system of claim 33, wherein the expulsion device comprises a wicking mechanism placed in series with the receiving substrate.

59. The osmolarity measuring system of claim 58, wherein the wicking mechanism is a microchannel.

60. The osmolarity measuring system of claim 59, wherein the microchannel comprises enhanced hydrophilic properties.

61. The osmolarity measuring system of claim 60, wherein the enhanced hydrophilic properties are achieved via at least one of a certain geometry, a substrate material and an applied coating.
